(19) United States
(12) Patent Application Publication
(10) Pub. No.: US 2005/0281936 A1
(43) Pub. Date: Dec. 22, 2005

(54) Natural food composition with stable color

(75) Inventor: Christopher Allen Wilson, Ridgefield Park, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America

(21) Appl. No.: 10/870,728

(22) Filed: Jun. 17, 2004

(51) Int. Cl. A01J 1/00

(52) U.S. Cl. 426/601

(57) ABSTRACT

An natural food composition with stable color is described. The food composition comprises a biodegradable surfactant and is bright white after manufacturing. The natural food composition of this invention and maintains a white color and does not turn pale-white or gray for at least about six months after manufacturing and when stored at ambient temperature.

### FIELD OF THE INVENTION

The present invention is directed to a natural food composition with a stable white color. More particularly, the invention is directed to a natural food composition comprising a biodegradable surfactant. The natural food composition of this invention, unexpectedly, is bright white after manufacturing and maintains a white color and does not turn pale-white or gray for at least about six months after manufacturing and when stored at ambient temperature.

### BACKGROUND OF THE INVENTION

Many salad dressings, dips, sauces and spoonable or pourable food products are oil-in-water emulsions. Such oil-in-water emulsions have a characteristic taste, texture and white color that enables them to connect with the consumer. Often, white products, like ranch dressings, transform from a white product (after manufacturing) to a pale-white or gray product after being stored at ambient temperature for about two months. In order to mask the color change and preserve product appeal, many manufacturers add inorganic (and synthetic) opacifiers, like titanium dioxide, to food products. Use of titanium dioxide, however, is not typically desirable because, while approved for food compositions in most countries, it is not perceived as a healthy or preferred food ingredient to consumers. Also, titanium dioxide may precipitate from food products, giving the same a non-attractive look, and it can deposit and leave residues on processing equipment.

Other options for modifying the color of food compositions include the use of modified starches. Debranched starches, as opacifiers, are often not desired since they can alter the taste of food compositions and add carbohydrates to the same when many consumers are concerned about reducing carbohydrate intake.

There is increasing interest to develop food compositions that taste good, are free of synthetic opacifiers and able to maintain a consumer acceptable white color, even when no starch-based and titanium based opacifiers are used. This invention, therefore, is directed to a natural food composition comprising a biodegradable surfactant. The natural food composition of this invention, unexpectedly, is bright white after manufacturing, and maintains a white color and does not turn pale-white or gray for at least about six months after manufacturing, even when stored at ambient temperature.

### ADDITIONAL INFORMATION

Efforts have been disclosed for making dressing compositions. In U.S. Pat. No. 6,231,913, a method for making dressing compositions is described.

Other efforts have been disclosed for making food products. In U.S. Pat. No. 5,194,284, food products opacified with debranched starch are described.

Still other efforts have been disclosed for preparing food compositions. In U.S. Pat. No. 6,060,106, opaque and low fat salad dressings with titanium dioxide are described.

None of the additional information above describes a natural food composition that has a stable white color, is free of synthetic opacifiers, and comprises a biodegradable surfactant.

### SUMMARY OF THE INVENTION

In a first aspect, the present invention is directed to a food composition comprising:
(a) oil;
(b) water, and
(c) a biodegradable surfactant,
   wherein the food composition is bright white after manufacturing, and does not turn pale-white or gray for at least about six months after manufacturing and when stored at ambient temperature.

In a second aspect, the present invention is directed to a method for making the food composition of the first aspect of this invention.

Bright white, as used herein, means a white color associated with an emulsion having at least about 80.0 percent of its total oil droplets with a diameter of less than about 17.0 microns (after manufacturing and after at least about six months at ambient temperature) and not having a gray or off-white appearance.

Natural food composition, as used herein, means substantially free of synthetic whiteners and opacifiers but preferably free of synthetic whiteners and opacifiers where substantially free means less than about 0.10 percent by weight based on total weight of the food composition.

### DETAILED DESCRIPTION OF THE PREFERRED EMBODIMENTS

There is no limitation with respect to the type of oil which may be used in the present invention other than that the oil is suitable for use in an edible food composition. Illustrative examples of the types of oil which may be used in this invention include, without limitation, those which are liquid at ambient temperature like avocado, mustard, coconut, cottonseed, fish, flaxseed, grape, olive, palm, peanut, rapeseed, safflower, sesame, soybean, sunflower, mixtures thereof and the like.

Other types of oils which may be used in this invention are solid at ambient temperature. Illustrative examples of the oils which are solid are room temperature include, without limitation, butter fat, chocolate fat, chicken fat, coconut oil, hydrogenated palm kernel oil, mixtures thereof and the like.

In a preferred embodiment, the oil used in this invention is a liquid at ambient temperature. In a most preferred embodiment, the oil used in this invention is soybean, sunflower or rapeseed oil, or a mixture thereof.

The amount of oil used in the natural food composition of this invention is typically more than about 25.0 weight percent and less than about 80.0 percent by weight, based on total weight of the food composition. Preferably, the amount of oil employed in the natural food composition is from about 30.0 to about 75.0 percent, and most preferably, from about 45.0 to about 55.0 percent by weight, based on total weight of the natural food composition and including all ranges subsumed therein.

The biodegradable surfactant employed in this invention is one which is suitable for use in food compositions. Typically, the biodegradable surfactant has a hydrophilic-lipophilic balance (HLB) from about 8.0 to about 14.0, and preferably, from about 11.0 to about 14.0, including all ranges subsumed therein. Examples of the types of biodegradable surfactants suitable for use in this invention include those which are saponins; and characterized as plant derived glycosides comprising at least one sapogenein portion and a sugar moiety.

The biodegradable surfactants suitable for use in this invention typically further comprise a steroid or a terpene portion linked to sugars like glucose and/or galactose, and are natural (i.e., found in nature).

Preferred saponins suitable for use in this invention are sterol glycosides isolated from plants. These preferred saponins include Yucca schidgera and Yucca valida. The especially preferred saponin suitable for use in this invention is quillaja derived from the Chilean endemic tree. Of the saponin surfactants used, those from Chilean endemic trees which are nonionic and have a molecular weight from about 1500 to about 2500 (Mw) are particularly preferred, and made available from suppliers like Desert King.

The amount of biodegradable surfactant employed in this invention typically does not exceed 0.175 percent by weight based on total weight of the natural food composition. Preferably, the biodegradable surfactant makes up from about 0.050 percent to about 0.150 percent, and most preferably, from about 0.075 percent to about 0.135 percent by weight of the natural food composition, including all ranges subsumed therein.

The water used in this invention can be pure water, tap water, bottled water, deionized water, spring water, or a mixture thereof. Thus, the water used in this invention may be an aqueous solution comprising salts or minerals or both. Typically, water makes up the balance of the food composition.

Preferred additives suitable for use in this invention are thickeners, and acidulants. The thickeners suitable for use in this invention include functional native starches (like Novation® from National Starch), locust bean, xanthan, carrageenan, guar gum and mixtures thereof. The preferred thickener suitable for use in this invention is xanthan gum, and thickener typically makes up from about 0.2 to about 1.0 percent, and preferably, from about 0.3 to about 0.85 percent, and most preferably, from about 0.35 to about 0.50 percent by weight of the natural food composition, based on total weight of the natural food composition and including all ranges subsumed therein.

There is no limitation with respect to the type of acidulant which may be employed in this invention other than that the acidulant is one which may be used in food compositions suitable for human consumption. Illustrative examples of the types of acidulants which may be used in this invention include, without limitation, acetic acid, citric acid, hydrochloric acid, lactic acid, malic acid, phosphoric acid, glucono-delta-lactone, mixtures thereof and the like. In a preferred embodiment, the acidulant employed in this invention is lactic acid or a mixture of hydrochloric or phosphoric acid and lactic acid, with lactic acid making up no more than about 40.0 percent by weight of the total weight of the acidulant mixture. The natural food composition typically has enough acidulant added so that the pH of the same is from about 2.75 to about 5.5, and preferably, from about 2.85 to about 5.50, and most preferably, from about 3.00 to about 4.00, including all ranges subsumed therein.

In an especially preferred embodiment, the natural food composition of this invention is an emulsion with the emulsifier being the above-identified biodegradable surfactant.

Optional emulsifiers that may be used with the biodegradable surfactant in the natural food composition of this invention are protein, like fruit, vegetable (e.g., pea protein), milk (e.g., whey) or soy protein, or mixtures thereof. Another preferred optional emulsifier suitable for use with the biodegradable surfactant used in this invention is phospholipoprotein (e.g., phospholipoprotein present in egg yolk, whole egg or enzyme modified egg), and especially, egg yolk derived phospholipoprotein modified with phospholipase A as disclosed in U.S. Pat. No. 5,028,447, the disclosure of which is incorporated herein by reference.

The amount of optional emulsifier employed in the natural food composition of this invention is typically equal to or less than the amount of biodegradable surfactant used. In a most preferred embodiment, only the biodegradable surfactant is used as the emulsifier and the emulsion is an oil-in-water emulsion.

When making the natural food composition of the present invention, emulsifier is typically added to the water, or oil, or both water and oil. The resulting water and oil phases can be mixed in a conventional mixer (e.g., under moderate sheer) to produce an edible coarse emulsion.

An edible emulsion (i.e., natural food composition) with a smooth texture is typically desired, and therefore, the coarse edible emulsion is preferably mixed in a conventional colloid mill or homogenized in, for example, a high pressure homogenizer. The homogenization step is typically carried out under pressures from about 20.0 to about 650.0 bar, and preferably, from about 40.0 to about 600.0 bar, and most preferably, from about 45.0 to about 550.0 bar, including all ranges subsumed therein. Typically, such a homogenization step is carried out at a temperature from about 15.0° C. to about 50° C. (preferably about ambient temperature). Mixing and/or homogenization is carried out for enough time to produce oil droplets (in the final natural food composition) whereby at least about 80.0 percent of the total amount of oil droplets in the emulsion have a diameter which is less than about 17 microns. In a preferred embodiment, at least about 85 percent of the total amount of oil droplets in the natural food composition have (after manufacturing) a diameter which is less than about 16.5 microns, and most preferably, less than about 16.0 microns.

Unexpectedly, the natural food composition of this invention maintains a white and not pale-white or gray color and maintains the above-defined oil droplet sizes, even after being stored at about room temperature for at least about six months. Moreover, after a period of at least about six months, the natural food composition of this invention has a mean volume particle size distribution from about 9.0 to 11.0 microns.

It is noted that in lieu of oil or in combination with oil, conventional fat substitutes may be used. Preferred fat substitutes employable in this invention include fatty acid-esterified alkoxylated glycerin compositions as well as sucrose fatty acid esters. The former and latter are described in U.S. Pat. Nos. 5,516,544 and 6,447,824, respectively, the disclosures of which are incorporated herein by reference. When employed, such conventional fat substitutes preferably make up at least about 30.0 percent, and most preferably, at least about 75.0 percent of the total weight of the oil in the natural food composition.

The edible emulsions described herein when combined with optional additives result to the desired natural food composition of this invention. Preferred optional additives which may be employed in the natural food composition made with the edible emulsion described herein include mustard flour, chocolate, nut paste, salt (and other spices and seasonings), vitamins, flavors and colors (e.g., beta carotene), fruit puree, preservatives, antioxidants, chelators, meat like ham and bacon bits or particulates, buffering agents, vegetable bits or particulates, fruit bits or particulates, mixtures thereof and the like. Such optional additives, when used, collectively, do not make up more than about 40.0 percent by weight of the total weight of the natural food composition.

When preparing the natural food composition of this invention, the optional additives may be added to water and/or oil before the emulsion is made, but preferably the optional additives are mixed in after the emulsion is made (especially when the optional additives are large, like fruit, vegetable or bacon bits).

Preservatives suitable for use in this invention include sodium benzoate, potassium benzoate, potassium sorbate, sorbic acid, benzoic acid, mixtures thereof and the like. The preferred preservative suitable for use in this invention is a bacteriocin like those sold by Quest International under the Perlac name. Anti-oxidants suitable for use in this invention include a tocopherol, ascorbic acid, ascorbyl palmitate, tertiary-butyl hydroquinone, mixtures thereof and the like. The preferred antioxidant, however, is a spice extract like the oregano-extract made commercially available by Rad Natural Technologies, Ltd. under the Origanox™ name. The especially preferred antioxidant is a rosemary extract sold under the Fortium™ name by Kemin Industries. Chelators suitable for use in this invention include EDTA and its salts, citric acid, sodium tripolyphosphate, sodium carbonate, potassium carbonate, mixtures thereof and the like.

The fruit and vegetable bits that may be used in natural food composition of this invention are typically small enough to fit through the orifice present in a conventional squeeze bottle. The vegetable bits often include peppers, carrots, cabbage, onion, broccoli, mixtures thereof and the like. The fruit bits often include pears, apples, grapes, tomatoes, mixtures thereof and the like.

Still other additives which may be optionally added to the natural composition of this invention include flavor enhancers like Mastertaste 1766 (hydrolyzed corn protein made available by Mastertaste, Inc.), food protein sources and sweeteners. The protein sauces include caseinate and skimmed milk powder and the sweeteners include syrups, sucrose, glucose, dextrose, lactose, levelose, maltose, fructose, mixtures thereof and the like. Artificial sweeteners can be used, but are not preferred.

The viscosity of the natural food composition of the present invention is typically greater than about 3,000 and less than about 100,000 centipoise. When a sauce or pourable dressing is, for example, the desired food product, the viscosity of the food product is preferably from about 4,000 to about 10,000 centipoise, and most preferably, from about 8,000 to about 20,000 centipoise.

The viscosity of the food composition is measured on a Haake Rheometer (Rotovisco RV20) at room temperature using a set of concentric cylinders (or bob-in-cup) with a 1 mm gap, the bob having a diameter of 1.0 cm and length of 1.0 cm. The inner cylinder or bob starts rotating from 0.0 shear and ramps up to a shear rate of 134 sec⁻¹ in 542 sec. By way of comparison, the viscosity values refer to the shear rate of 10 sec⁻¹.

The packaging for the food products comprising the edible emulsion of this invention is often a glass jar, food grade sachet or squeezable plastic bottle. Sachets are preferred for food service applications, and a plastic bottle is preferred for domestic use.

It is especially noted that in a preferred embodiment, the natural food composition of the present invention is a ranch dressing, and especially one with 100% natural ingredients. In another preferred embodiment, the amount of thickener used in the natural food composition of this invention is at least two times, and preferably three times greater than the amount of biodegradable surfactant employed.

The examples which follow are provided to facilitate an understanding of the present invention. The examples are not intended to limit the scope of the claims.

### EXAMPLE 1

Ranch dressings were made by mixing in a colloid mill the following ingredients.

| Ingredient | Percent by Weight |
|---|---|
| Soybean oil | 45.0-48.0 |
| Vinegar | 4.5-5.5 |
| Whey | 1.0-1.5 |
| Sucrose | 1.8-2.2 |
| Salt | 1.7-1.9 |
| Garlic powder | 0.75-0.80 |
| Onion powder | 0.47-0.50 |
| Xanthan gum | 0.38-0.45 |
| Lactic Acid (55%) | 0.23-0.26 |
| Flavor | 0.055-0.075 |
| Pepper | 0.065-0.075 |
| Parsley (granulated) | 0.014-0.015 |
| Tomato juice | 0.8-0.9 |
| Biodegradable surfactant | 0.15-0.17 |
| Flavor enhancer | 0.4-0.5 |
| Natural starch thickener | 0.2-0.25 |
| Natural antioxidant | 0.065-0.1 |
| Water | Balance |

The resulting mixture (Ranch Dressing) was homogenized in a homogenizer under conditions to produce a natural food composition (i.e., emulsion) having at least about 90.0% of all oil droplets with a diameter of less than about 16 microns. Unexpectedly, the homogenized ranch dressing was bright white after manufacturing and not pale-white or gray after being stored at ambient temperature for about six months. Also, after about six (6) months at ambient temperature, the ranch dressing was good tasting and the oil droplet sizes were essentially unchanged, with a mean volume particle size distribution of about 10.40 microns.

### EXAMPLE 2

Ranch dressings similar to one described in Example 1 were made except no biodegradable surfactant was used and water was added in lieu of the same. The resulting ranch dressings, immediately after manufacturing, were not as white as the dressings made in Example 1. Also, after about six (6) months at ambient temperature, the ranch dressings without the biodegradable surfactant were pale-white and gray and had oil droplet size distributions that were at least twice as large as the distributions observed for the ranch dressings made in Example 1.

The results unexpectedly indicate that by employing less than about 0.175 percent by weight biodegradable surfactant, an emulsion with a more stable, and whiter appearance can be made.

1. A food composition comprising:
(a) oil;
(b) water, and
(c) a biodegradable surfactant,
wherein the food composition is bright white after manufacturing, and does not turn pale-white or gray for at least about six months after manufacturing and when stored at ambient temperature.

2. The food composition according to claim 1 wherein the food composition is an emulsion.

3. The food composition according to claim 2 wherein the emulsion is an oil-in-water emulsion.

4. The food composition according to claim 1 wherein the biodegradable surfactant is a saponin.

5. The food composition according to claim 4 wherein the saponin is non-ionic and has a molecular weight from about 1500 to about 2500.

6. The food composition according to claim 5 wherein the saponin is from a Chilean endemic tree.

7. The food composition according to claim 1 wherein the biodegrable surfactant does not exceed 0.175 percent by weight of the food composition.

8. The food composition according to claim 1 wherein the food composition further comprises a thickener in an amount from about 0.2 to about 1.0 percent by weight.

9. The food composition according to claim 1 wherein the food composition has a pH from about 2.75 to about 5.5.

10. The food composition according to claim 1 wherein the food composition has a viscosity from about 3,000 to about 100,000 centipoise.

11. The food composition according to claim 1 wherein the food composition has a viscosity from about 8,000 to about 20,000 centipoise.

12. The food composition according to claim 3 wherein the ranch dressing is a ranch dressing.

13. The food composition according to claim 12 wherein the food composition is formulated only with natural ingredients.

14. The food composition according to claim 1 wherein the amount of thickener employed is at least two times greater than the amount of biodegradable surfactant employed.

15. The food composition according to claim 1 wherein the food composition has a mean volume particle size distribution from about 9.0 to about 11.0 microns.

16. A method for making a natural food composition comprising, in no particular order, the steps of:
(a) combining water, oil and emulsifier to produce a coarse emulsion;
(b) milling the course emulsion to produce an emulsion comprising a mean volume particle size distribution from about 9.0 to about 11.0 microns
wherein the emulsifier is a biodegradable surfactant.

17. A method for making a natural food composition according to claim 16 wherein the food composition further comprises a thickener and thickener is present in an amount that is at least two times greater than the emulsifier amount.

18. A method for making a natural food composition according to claim 16 wherein the natural food composition is not pale-white or gray after about six (6) months at ambient temperature.

19. A method for making a natural food composition according to claim 16 wherein the biodegradable surfactant is a saponin.

20. A method for making a natural food composition according to claim 19 wherein the saponin is from a Chilean endemic tree.
